(19) United States
(12) Patent Application Publication
(10) Pub. No.: US 2017/0272952 A1
(43) Pub. Date: Sep. 21, 2017

(54) User Management Method and Electronic Device

(71) Applicants: Le Holdings (Beijing) Co., Ltd., Beijing (CN); Lemobile Information Technology (Beijing) Co., Ltd, Beijing (CN)

(72) Inventor: Hailin Ren, Beijing (CN)

(21) Appl. No.: 15/241,633

(22) Filed: Aug. 19, 2016

Related U.S. Application Data
(63) Continuation of application No. PCT/CN2016/088327, filed on Jul. 4, 2016.

(30) Foreign Application Priority Data
Mar. 21, 2016 (CN) 201610161703.1

(51) Int. Cl. H04W 12/08; H04L 29/06; H04W 8/18; G06K 9/00; H04W 4/00; H04W 12/06

(52) U.S. Cl. CPC H04W 12/08; H04W 4/008; H04W 12/06; H04W 8/183; G06K 9/00087; G06K 9/00013; H04L 63/0861; G06Q 20/102

(57) ABSTRACT

The application discloses a user management method and an electronic device. The user management method includes the following steps: acquiring a user fingerprint in response to a request for a current operation; recognizing a user identity according to the acquired user fingerprint; judging whether a current user has a permission to execute the current operation; and executing the current operation upon judgment that the current user has the permission. Thus, flexible judgment and management can be conducted according to actual conditions, thereby enhancing the management effect.

### CROSS REFERENCE TO RELATED APPLICATIONS

This application is a continuation of International Application No. PCT/CN2016/088327, filed on Jul. 4, 2016, which is based upon and claims priority to Chinese Patent Application No. 201610161703.1, filed on Mar. 21, 2016, titled “User Management Method, User Management System and User Terminal”, the entire contents of which are incorporated herein by reference.

### TECHNICAL FIELD

The application relates to the technical field of electronics, and particularly relates to a user management method and electronic device.

### BACKGROUND

In the prior arts, with the popularization of intelligent terminal devices, such as computers, mobile phones, etc., their powerful functions attract more and more teenagers and children to indulge in them. Taking the mobile phones as an example, the mobile phones can be used for listening to music, watching videos, surfing the Internet, playing games, etc. However, children often play the mobile phones for too long time or at an inappropriate time due to their young age and poor self-control, which causes a distraction from study and is bad for health.

To help the children to correctly use the intelligent terminal devices, such as the computers, the mobile phones, etc., the terminal devices should be effectively managed. The existing main management means are as follows.

Management applications can be installed, but most of the applications have simple functions, only such functions as locking the devices within a specified time, prohibiting access to or shielding specified applications, controlling the use time of the devices or specified applications, allowing or prohibiting access to specified websites, etc. are achieved according to preset rules, and flexible judgment and management cannot be conducted according to actual conditions.

System-level modes, such as a guest mode, a children mode, etc. can be added to an operating system, but the modes are often simpler.

### SUMMARY

The application provides a user management method and an electronic device, and solves the technical problems that the functions of existing terminal management means are simple, and judgment and management cannot be conducted according to actual conditions.

Therefore, the embodiments of the application provide a user management method, including acquiring a user fingerprint in response to a request for a current operation; recognizing a user identity according to the acquired user fingerprint, wherein different permissions are set for different user identities; judging whether a current user has a permission to execute the current operation; and executing the current operation upon judgment that the current user has the permission.

Preferably, the current operation includes making and/or answering a call; enabling a data service; accessing a preset application; uninstalling or installing an application; or making a payment.

Preferably, the data service includes a mobile network, a wireless network, Bluetooth or NFC.

The application further provides an electronic device, including: at least one processor; and a memory communicably connected with the at least one processor for storing instructions executable by the at least one processor, wherein execution of the instructions by the at least one processor causes the at least one processor to: acquire a user fingerprint in response to a request for a current operation; recognize a user identity according to the acquired user fingerprint, wherein different permissions are set for different user identities; judge whether a current user has a permission to execute the current operation; and execute the current operation upon judgment that the current user has the permission.

The electronic device, wherein, the current operation includes: making and/or answering a call; enabling a data service; accessing a preset application; uninstalling or installing an application; or making a payment.

The electronic device, wherein, the data service includes a mobile network, a wireless network, Bluetooth or NFC.

The application also provides a non-transitory computer-readable storage medium storing executable instructions that, when executed by an electronic device, cause the electronic device to: acquire a user fingerprint in response to a request for a current operation; recognize a user identity according to the acquired user fingerprint, wherein different permissions are set for different user identities; judge whether a current user has a permission to execute the current operation; and execute the current operation upon judgment that the current user has the permission.

The non-transitory computer-readable storage medium, wherein, the current operation includes: making and/or answering a call; enabling a data service; accessing a preset application; uninstalling or installing an application; or making a payment.

The non-transitory computer-readable storage medium, wherein, the data service includes a mobile network, a wireless network, Bluetooth or NFC.

In the user management method and electronic device provided in the embodiment of the application, user permissions are set for operations in advance, and when a current operation is requested, a user is identified by use of a fingerprint such that whether the user has a permission to execute the current operation is judged. Therefore, a user with a high privilege level can conduct flexible judgment and management according to actual conditions, thereby enhancing the management effect.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a user management method in the embodiments of the application.

FIG. 2 is a structural block diagram of a user management system in the embodiments of the application.

FIG. 3 is a schematic diagram of hardware configuration of an electronic device in the embodiments of the application.

### DETAILED DESCRIPTION

In order to clearly describe objectives, the technical solutions and advantages of the application. A clear and complete description of the technical solutions in the application will be given below, in conjunction with the accompanying drawings in the embodiments of the application. Apparently, the embodiments described below are a part, but not all, of the embodiments of the application.

### Embodiment 1

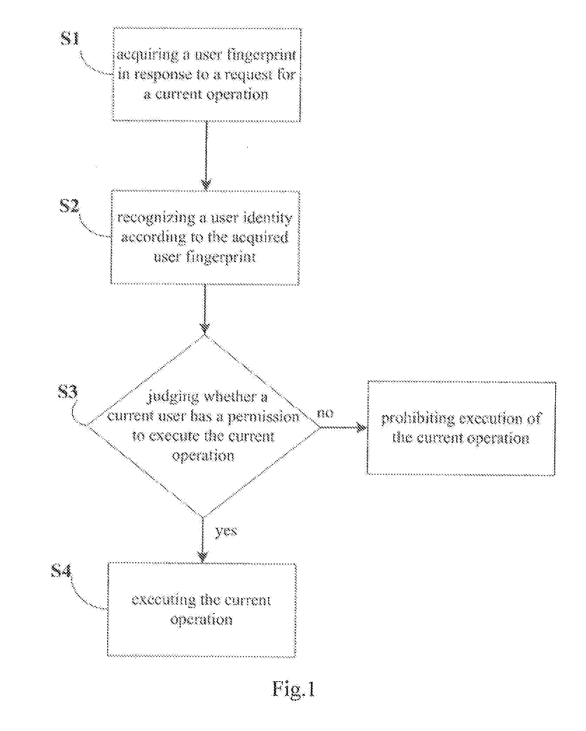

As shown in FIG. 1, the embodiment of the application provides a user management method including the following steps:

S1. a user fingerprint is acquired in response to a request for a current operation. Specifically, when a user initiates the request for the current operation, a fingerprint acquisition interface is displayed in a form of a full screen window or a float window and gets the focus, and requests the user either to accept fingerprint acquisition or to withdraw the request for the current operation; and when the user withdraws the request for the current operation, the fingerprint acquisition interface is closed to return to an interface before the current operation is requested. Preferably, the current operation includes but not limited to: making and/or answering a call; enabling a data service; accessing a preset application; uninstalling or installing an application; or making a payment, etc., wherein the data service can include: a mobile network provided by a mobile network provider (such as CMCC, China Telecom, China Unicom, etc.), a wireless network (such as WIFI), Bluetooth or near field communication (NFC);

S2. a user identity is recognized according to the acquired user fingerprint, wherein different permissions are set for different user identities;

wherein, a plurality of fingerprints may be stored in the existing terminal device, but the permissions of the fingerprints have no difference, for example, all the fingerprints have the permissions for unlocking. Differently, in the embodiment of the application, a plurality of fingerprint databases can be set up. A plurality of fingerprints can be stored in each fingerprint database. Each fingerprint database corresponds to one user, and a permission can be independently set for each user to allow or prohibit execution of specified operation;

S3. whether a current user has a permission to execute the current operation is judged. Step S4 is executed upon judgment that the current user has the permission; and the current operation is prohibited from being executed upon judgment that the current user has no permission; and preferably, a message window can pop up simultaneously to inform the user, allowing the user to choose “Try Again” or directly go back; wherein, different users have different permissions. For example, for entertainment software, only specific users, such as parents, have a permission to access the applications. Of course, part of the operations can be set in such a manner that all users have permissions as needed, such as screen unlocking or learning and tool software;

S4. the current operation is executed upon judgment that the current user has the permission. Specifically, after the current operation exits, if the current operation is requested again, the user is still required to be verified again, i.e., subjected to fingerprint identification. Preferably, a preset time can also be set, and after the preset time elapses since the beginning of the execution of the current operation, the user is required to be verified again. Preferably, when an application (such as a dictionary and a browser) corresponding to the current operation is switched between a foreground and a background, the user is not required to be verified again.

In the user management method of the embodiment of the application, user permissions are set for the operation in advance and when the current operation is requested, the user is identified by use of the fingerprint such that whether the user has a permission to execute the current operation is judged. Therefore, a user with a high privilege level can conduct flexible judgment and management according to actual conditions, thereby enhancing the management effect. In addition, compared with a traditional password, the fingerprint has the features of being difficult to replicate and more convenient.

### Embodiment 2

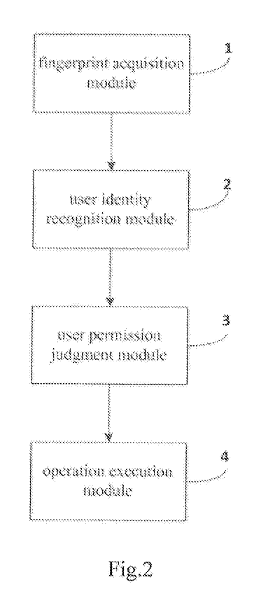

As shown in FIG. 2, the embodiment of the application also provides a user management system including the following modules. A fingerprint acquisition module 1 is used for acquiring a user fingerprint in response to a request for a current operation. Specifically, the fingerprint identification module includes an optical fingerprint module, a capacitive fingerprint module or a radio frequency fingerprint module. Preferably, the current operation includes but not limited to: making and/or answering a call; enabling a data service; accessing a preset application; uninstalling or installing an application; or making a payment, etc., wherein the data service can include a mobile network provided by a mobile network provider (such as CMCC, China Telecom, China Unicom, etc.), a wireless network (such as WIFI), Bluetooth or near field communication (NFC).

A user identity recognition module 2 is used for recognizing a user identity according to the acquired user fingerprint, wherein different permissions are set for different user identities. Specifically, a plurality of fingerprint databases can be set up in advance. A plurality of fingerprints can be stored in each fingerprint database. Each fingerprint database corresponds to one user, and a permission can be independently set for each user to allow or prohibit the execution of a specified operation. The user identity recognition module matches the fingerprint acquired by the fingerprint acquisition module with the fingerprints in the fingerprint databases. If a matched fingerprint is found, it indicates that the user requesting the current operation is a registered user of the device.

A user permission judgment module 3 is used for judging whether a current user has a permission to execute the current operation. A judgment result is sent to an operation execution module 4 upon the judgment that the current user has the permission; and upon the judgment that the current user has no permission, preferably, a message window can pop up to inform the user, allowing the user to choose “Try Again” or directly go back. Different users have different permissions. For example, for entertainment software, only specific users, such as parents, have a permission to access the applications. Of course, part of the operations can be set in such a manner that all users have permissions as needed, such as screen unlocking or learning and tool software.

An operation execution module 4 is used for executing the current operation when the user permission judgment module 3 judges that the current user has the permission. Specifically, after the current operation exits, if the current operation is requested again, the user is still required to be verified again, i.e., subjected to fingerprint identification. Preferably, a preset time can also be set, and after the preset time elapses since the beginning of the execution of the current operation, the user is required to be verified again. Preferably, when an application (such as a dictionary and a browser) corresponding to the current operation is switched between a foreground and a background, the user is not required to be verified again.

In the user management system of the embodiment of the application, user permissions are set for the operation in advance, and when the current operation is requested, the user is identified by use of the fingerprint such that whether the user has a permission to execute the current operation is judged. Therefore, a user with a high privilege level can conduct flexible judgment and management according to actual conditions, thereby enhancing the management effect. In addition, compared with a traditional password, the fingerprint has the features of being difficult to replicate and more convenient.

### Embodiment 3

The embodiment of the application also provides a user terminal which includes any above user management system. Preferably, the user terminal includes a mobile phone, a tablet personal computer, a laptop computer or a desktop computer.

### Embodiment 4

A non-transitory computer-readable storage medium storing executable instructions that, when executed by an electronic device, cause the electronic device to: acquire a user fingerprint in response to a request for a current operation; recognize a user identity according to the acquired user fingerprint, wherein different permissions are set for different user identities; judge whether a current user has a permission to execute the current operation; and execute the current operation upon judgment that the current user has the permission.

The non-transitory computer-readable storage medium, wherein, the current operation includes: making and/or answering a call; enabling a data service; accessing a preset application; uninstalling or installing an application; or making a payment.

The non-transitory computer-readable storage medium according to claim 8, wherein, the data service includes a mobile network, a wireless network, Bluetooth or NFC.

### Embodiment 5

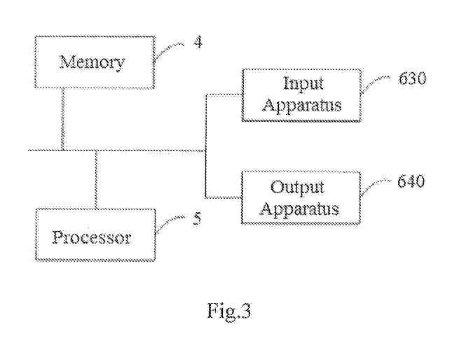

FIG. 3 is a schematic diagram of the hardware configuration of the electronic device provided by the embodiment, which performs the user management method. As shown in FIG. 3, the electronic device includes: one or more processors 5 and a memory 4, wherein one processor 5 is shown in FIG. 3 as an example. The electronic device that performs the user management method further includes an input apparatus 630 and an output apparatus 640.

The processor 5, the memory 4, the input apparatus 630 and the output apparatus 640 may be connected via a bus line or other means, wherein connection via a bus line is shown in FIG. 3 as an example.

The memory 4 is a non-transitory computer-readable storage medium that can be used to store non-transitory software programs, non-transitory computer-executable programs and modules, such as the program instructions/modules corresponding to the user management method of the embodiments of the application (e.g. fingerprint acquisition module 1, user identity recognition module 2, user permission judgment module 3, and operation execution module 4 shown in the FIG. 2). The processor 5 executes the non-transitory software programs, instructions and modules stored in the memory 4 so as to perform various function application and data processing of the server, thereby implementing the user management method of the above-mentioned method embodiments

The memory 500 includes a program storage area and a data storage area, wherein, the program storage area can store an operation system and application programs required for at least one function; the data storage area can store data generated by use of the user management system. Furthermore, the memory 4 may include a high-speed random access memory, and may also include a non-volatile memory, e.g. at least one magnetic disk memory unit, flash memory unit, or other non-volatile solid-state memory unit. In some embodiments, optionally, the memory 4 includes a remote memory accessed by the processor 5, and the remote memory is connected to the user management system via network connection. Examples of the aforementioned network include but not limited to internet, intranet, LAN, GSM, and their combinations.

The input apparatus 630 receives digit or character information, so as to generate signal input related to the user configuration and function control of the user management system. The output apparatus 640 includes display devices such as a display screen.

The one or more modules are stored in the memory 4 and, when executed by the one or more processors 5, perform the user management method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof. Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

What is claimed is:

1. A user management method, comprising:
acquiring a user fingerprint in response to a request for a current operation;
recognizing a user identity according to the acquired user fingerprint, wherein different permissions are set for different user identities;
judging whether a current user has a permission to execute the current operation; and
executing the current operation upon judgment that the current user has the permission.

2. The method according to claim 1, wherein, the current operation comprises:
making and/or answering a call;
enabling a data service;
accessing a preset application;
uninstalling or installing an application; or
making a payment.

3. The method according to claim 2, wherein, the data service comprises:
a mobile network, a wireless network, Bluetooth or NFC.

4. An electronic device, comprising: at least one processor; and a memory communicably connected with the at least one processor for storing instructions executable by the at least one processor, wherein execution of the instructions by the at least one processor causes the at least one processor to:
acquire a user fingerprint in response to a request for a current operation;
recognize a user identity according to the acquired user fingerprint, wherein different permissions are set for different user identities;
judge whether a current user has a permission to execute the current operation; and
execute the current operation upon judgment that the current user has the permission.

5. The electronic device according to claim 4, wherein, the current operation comprises: making and/or answering a call; enabling a data service; accessing a preset application; uninstalling or installing an application; or making a payment.

6. The electronic device according to claim 5, wherein, the data service comprises:
a mobile network, a wireless network, Bluetooth or NFC.

7. A non-transitory computer-readable storage medium storing executable instructions that, when executed by an electronic device, cause the electronic device to:
acquire a user fingerprint in response to a request for a current operation;
recognize a user identity according to the acquired user fingerprint, wherein different permissions are set for different user identities;
judge whether a current user has a permission to execute the current operation; and
execute the current operation upon judgment that the current user has the permission.

8. The non-transitory computer-readable storage medium according to claim 7, wherein, the current operation comprises:
making and/or answering a call;
enabling a data service;
accessing a preset application;
uninstalling or installing an application; or
making a payment.

9. The non-transitory computer-readable storage medium according to claim 8, wherein, the data service comprises:
a mobile network, a wireless network, Bluetooth or NFC.
